(19) United States
(12) Patent Application Publication
(10) Pub. No.: US 2013/0290101 A1
(43) Pub. Date: Oct. 31, 2013

(54) MEDIA-ENABLED DELIVERY OF COUPONS

(71) Applicants: Nick Salvatore ARINI, Southhampton (GB); Simon Michael ROWE, Berkshire (GB); Ken KRIEGER, Jackson, WY (US)

(72) Inventors: Nick Salvatore ARINI, Southhampton (GB); Simon Michael ROWE, Berkshire (GB); Ken KRIEGER, Jackson, WY (US)

(73) Assignee: Google Inc., Mountain View, CA (US)

(21) Appl. No.: 13/456,114

(22) Filed: Apr. 25, 2012

(51) Int. Cl. G06Q 30/02

(52) U.S. Cl. 705/14.55; 705/14.49

(57) ABSTRACT

A method, and a corresponding system, provides for media-enabled delivery of coupons. The method includes providing a trigger for an advertisement, with the advertisement provided in a media stream for display to a viewer on a media display device. Activation of the trigger displays an option for acquiring a coupon. The method further includes receiving a coupon generation request from the viewer of the advertisement; receiving an identity of the media display device and metadata related to a display of the advertisement; determining eligibility for generation and delivery of the coupon; and if eligible, determining a coupon delivery option, and delivering the coupon.

### BACKGROUND

Advertisement over, or in, various media is used to entice consumers to purchase products and services. Television, as a media delivery vehicle, provides an ideal advertisement platform because of its ubiquitous presence. Television historically consisted of broadcast programs as the sole available media type, and advertisers paid to have their advertisements displayed during the airing of certain programs. More recently, television has included streaming programs, pay-per-view movies and games, and other media distributed over the Internet. These mixed media types also support display of advertisements.

Coupons play a dual role in selling products and services. Coupons typically offer a price reduction for a product or a service, and thus may be used to boost sales by enticing consumers to purchase products or services. Coupons also can be used to measure the efficacy of an advertisement or an advertisement campaign.

One measure of the success of an advertisement is the number of conversions that occur as a result of that advertisement. Conversions typically include product or service purchases, visits to a related Web site, requests for information, such as a product brochure, and acquisition and use of a coupon related to the advertised product or service. However, determining conversions is difficult and imprecise.

Coupons may be delivered by a variety of methods, including direct mailing, posting on Internet Web sites, and attaching coupons to products. However, these methods often do not target specific consumers or consumer groups. Furthermore, these methods do not necessarily tie the acquisition of a coupon by a consumer to viewing of a related advertisement by that viewer.

### DESCRIPTION OF THE DRAWINGS

The detailed description will refer to the following Figures, in which like numerals refer to like items, and in which:

FIG. 1 illustrates an embodiment of an environment in which media-enabled delivery of coupons is provided;

FIG. 2 illustrates an embodiment of an environment in which television-enabled printing of coupons is provided;

FIG. 3 illustrates an embodiment of a trigger used with media-enabled delivery of coupons, including television-enabled printing;

FIGS. 4A and 4B illustrate embodiments for displaying a coupon interface used with television-enabled printing of coupons;

FIG. 5 illustrates an embodiment of a coupon request message, and associated response, generated by the components of FIG. 1 or 2;

FIG. 6 is a block diagram of an embodiment of a system for television-enabled printing of coupons;

FIG. 7 is an overall block diagram of an embodiment of a software system that supports television-enabled printing of coupons;

FIGS. 8A-8D are more detailed block diagrams of the software system of FIG. 7;

FIG. 9 illustrates an embodiment of the arrangement of programming modules distributed among the various components shown in FIG. 2;

FIG. 10 illustrates another embodiment of the arrangement of programming modules distributed among the various components shown in FIG. 2; and

FIGS. 11A and 11B are flow charts illustrating embodiments of methods for television-enabled printing of coupons.

### DETAILED DESCRIPTION

Coupons are used to entice consumers to purchase products or services. Coupons may be delivered by a variety of methods, including direct mailing, posting on Internet Web sites, and attaching coupons to products. However, these methods do not necessarily target specific consumers or consumer groups. Furthermore, these methods do not necessarily tie the acquisition of a coupon by a consumer to viewing of a related advertisement by that viewer. That is, these methods do not allow for an accurate measurement of conversion.

Disclosed herein is media-enabled delivery of coupons, a specific implementation of which is television-enabled printing of coupons, and even more specifically, television-enabled cloud printing of coupons. Television-enabled cloud printing of coupons allows advertisers to more accurately measure conversion; that is, acquisition of a coupon based on viewing of an advertisement. Television-enabled cloud printing of coupons also allows a closer match between a potential consumer, and the coupons available and presented to that consumer. That is, television-enabled cloud printing of coupons allows for targeting coupons to consumers. In addition, television-enabled cloud printing of coupons provides greater convenience for the consumer in acquiring coupons.

In an embodiment of media-enabled delivery of coupons, television-enabled cloud printing of coupons provides an indication, during display of media on a first device such as a television, that a coupon for a product or service is available. The indication may be generated by a trigger embedded in the media being displayed. This indication may be provided at the beginning of an advertisement, and may persist for a specified period. In an embodiment, an individual viewing the advertisement signals a desire to acquire the coupon using a second device such as a television remote control device or a mobile device such as a smart phone. In another embodiment, an individual is viewing television programming on a mobile device such as a tablet, and the advertisement is displayed on the tablet. The individual then uses a touch-sensitive button of the tablet's screen to signify a desire to acquire a coupon. In either embodiment, a coupon request message then is sent to a coupon server located remotely from the individual, and a coupon is rendered and delivered to a device accessible to the individual. The coupon request message may contain time and date information related to when the indication is provided, and the channel to which the television is tuned during the display of the indication, if appropriate. The coupon request message may include an identification of the device that sent the coupon request message. The coupon request message also may include an individual identifier, which is anonymized, and which may be provided as an opt in/opt out feature that the individual can choose. The coupon server may limit generation and delivery of coupons based on a period between display of the indication and receipt of the coupon request message.

Television-enabled cloud printing of coupons provides multiple mechanisms for delivery of coupons to the consumer, including: 1) by printing at the consumer's local printer, 2) printing at a remote printer, using a cloud printing service, for example, 3) by electronic mail, 4) by regular mail, and 5) by delivery as an electronic coupon to the consumer's mobile device such as a smart phone or tablet, or to the consumer's Internet-enabled television.

The indication that a coupon is available may be provided in a coupon interface that is displayed for a limited time on the television screen. In an alternative, the coupon interface is displayed on a second device, such as a smart phone. In another alternative, the second device, such as a smart phone, uses audio matching to detect an advertisement being displayed. The second device then provides the coupon interface. Whether displayed on the television or on the second device, in an embodiment, the coupon interface includes a message that a coupon or offer is available, and further includes a mechanism to initiate a coupon request message. In an embodiment, the mechanism is a quick response bar code displayed on the television screen, which may be scanned using the second device. In another embodiment, the mechanism includes an accept tab and a skip tab. Selecting the accept tab, using either a television remote control or the second device, causes the coupon request message to be generated, while selecting the skip tab causes the coupon interface to disappear from display. In another embodiment, both mechanisms may be combined in the coupon interface.

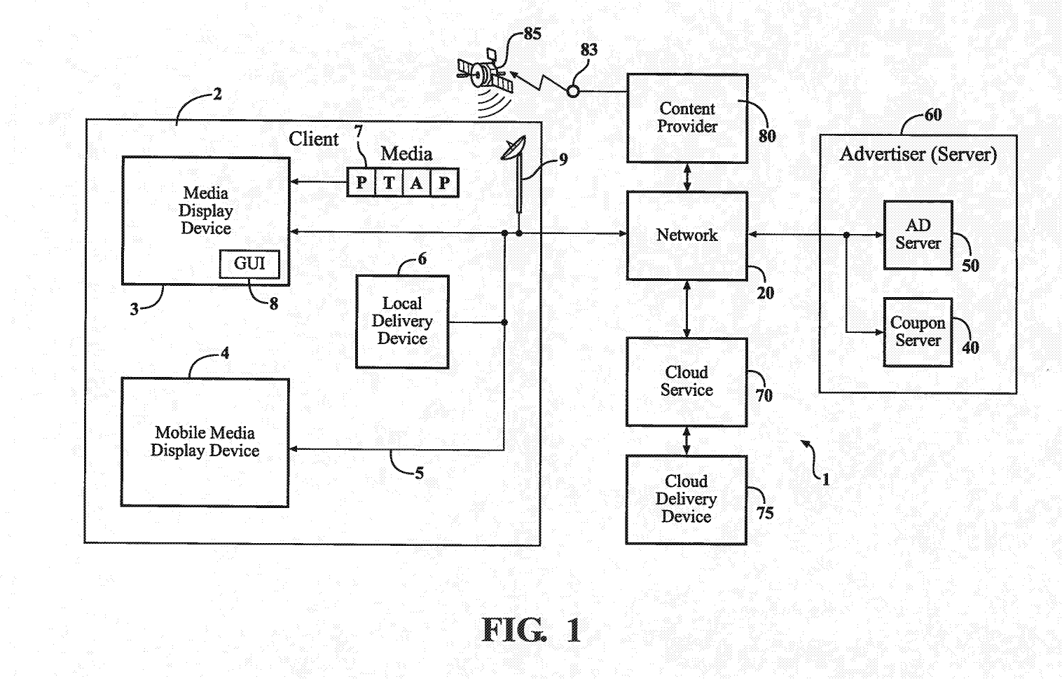

FIG. 1 illustrates an embodiment of an environment for media-enabled delivery for coupons. In FIG. 1, environment 1 includes client 2, which is coupled through network 20 to advertiser (server) 60, cloud service 70, and content provider 80. Advertiser (server) 60 is part of an advertisement service, and includes ad server 50 and coupon server 40. Content provider 80 provides media for display at client 2, using either network 20 or antenna 83 and satellite 85. In FIG. 1, the content provider 80 combines the functions of program provider and program distributor (i.e., broadcaster, Web host). Cloud service 70 includes remote programming (not shown) to accomplish a variety of tasks, and cloud delivery device 75 for delivery and storage of data and content as directed by either the client 2 or the advertiser server 60.

The network 20 may be a wide area network (WAN), local area network (LAN), cellular network, or any other type of network operative to connect the different components of environment 1. The network 20 may include the Internet and connections to media providers, such as the content provider 80. The 2 may connect to the network 20 by wired or wireless means, or both wired and wireless means.

The client 2 receives media 7, including programming P from content provider 80, to which has been added advertisement A and optional trigger T. The media 7 may be broadcast or streaming video, still images, games, and pay-per-view events such as pay-per-view movies, or any other type of media. The client 2 may receive the media 7 over the network 20 and by reception at multi-purpose antenna 9. Media received at antenna 9 may be broadcast over the air or sent using satellite 85.

The client 2 receives the media 7 at media display device 3. Alternately, or in addition, the client 2 may receive the media 7 at mobile media display device 4. In an embodiment, media display device 3 is a television and mobile media display device 4 is a mobile device such as a tablet or smart phone having a viewing screen for display of the media 7. Finally, the client 2 includes local delivery device 6, which may be a networked printer or storage device. The components shown at the client 2 are coupled by local area network (LAN) 5, which in turn couples the client components to the network 20.

Coupon delivery in the environment 1 of FIG. 1 operates as follows. The ad server 50 provides advertisements A for insertion into the media 7. When the advertiser desires to offer a coupon in connection with the advertisement A, the advertiser (server) 60 includes a trigger T to be inserted with the advertisement A in the media 7. The trigger T may be inserted at the leading edge of the advertisement A. When a processor (not shown) in the media display device 3 detects the presence of the trigger T, programming executable by the processor causes a display, which in an embodiment is a graphical user interface (GUI) 8, to be displayed momentarily at the media display device 3. The GUI 8 indicates that a coupon associated with the product of advertisement A is available, and allows an individual at the client 2, who is observing display of the media 7, including the advertisement A, to request delivery of the coupon. In the environment 1 shown in FIG. 1, such delivery can be to a designated device such as the local delivery device 6, the cloud delivery device 75, or either of the media display devices 3 and 4. To take advantage of the coupon offer, the individual operates mobile media display device 4 in a manner prescribed by the GUI 8 to record information regarding the coupon, and information (i.e., metadata) related to the advertisement A such as the channel over which the advertisement A is shown and the date and time of display of the advertisement A. The GUI 8 may provide a feature that can be scanned by the mobile media display device 4 and/or may display accept/skip tabs that can be selected using the mobile media display device 4. Once a coupon request is initiated by actions of the individual, the mobile media display device 4 generates a coupon request message, including the coupon information, the advertisement metadata, and, when available, an identity of the individual and the device originating the coupon request message. Such identities may be available, subject to the individual's approval, when the individual registers one or both of the media display devices 3 and 4 with a service, such as an Internet provider (not shown), logs on (e.g., enters a user name and password) to a service, or by noting the IP address of the requesting device, for example. One advantage of collecting the coupon information, advertisement information, and individual identification is that it allows the advertiser (server) 60 to measure the efficacy of an advertisement or advertisement campaign without having to have the associated coupon redeemed. That is, the coupon request message represents a conversion. In return for the coupon request message, the advertiser (server) 60, using the coupon server 40, provides the requested coupon for ultimate delivery to a device as directed by the individual.

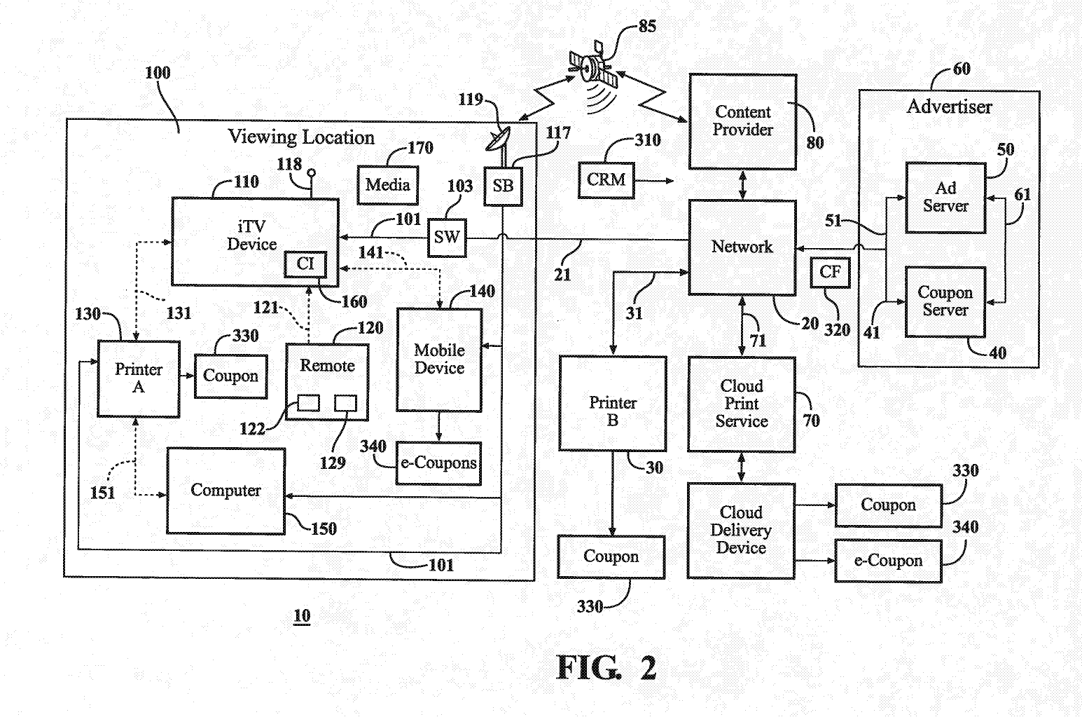

FIG. 2 illustrates an embodiment of an environment in which television-enabled printing of coupons, is provided. In FIG. 2, environment 10 includes television viewing location 100, which is coupled to network (e.g., Internet) 20 using communications path 101, switching device 103, and communications path 21. Also coupled to the network 20 are remote printer (printer B) 30, using communications path 31, advertiser 60, including coupon server 40, using communications path 41, ad server 50, using communications path 51, cloud service 70, using communications path 71, and content provider 80, using communications path 81.

The printer B 30 is located away from the viewing location 100, and may be, for example, at the individual's place of work, at a service store, a hotel business center, or other location remote from the viewing location 100, as long as the printer B 30 can receive a print command from one of the devices at the viewing location, or from another device such as the coupon server 40.

The coupon server 40 and the ad server 50 may be co-located, or dispersed, and may belong to the advertiser 60 as shown, or to separate entities. The coupon server 40 and ad server 50 may be in communication using communications path 61 or using communications paths 41 and 51 through network 20.

The cloud service 70 may be a cloud printing service, and may direct the printing of a coupon at a printer designated by an individual requesting the coupon.

The television viewing location 100 may include an Internet-enabled television (iTV) device 110, and a number of devices that may interact with the iTV device 110. These devices include remote control device (remote) 120, local printer (printer A) 130, mobile device 140, and computer 150. The iTV device 110 may be an Internet-enabled “smart” television. Such Internet-enabled smart televisions are well known in the art. As an alternative, the iTV device 110 may be a non-Internet enabled “basic” television that is coupled to a set top box, the set top box including processors and Internet connectivity features. Such set top boxes are well known in the art. As yet another alternative, an intermediate device may connect a basic television to the Internet to form the iTV device 110. Examples of such intermediate devices include streaming digital video players. The iTV device 110 will be referred to hereafter as iTV 110. The iTV 110 may receive broadcast, over-the-air programming (e.g., media 170) at antenna 118, or satellite-provided programming at antenna 119 and satellite box 117. The remote 120 may be wired or wireless. In its wireless form, the remote 120 may communicate with the iTV 110 by WiFi, infrared, or other wireless signaling. The remote 120 includes coupon offer selection features that can be used to signal acceptance or rejection of a coupon offer. In an embodiment, the coupon offer selection features are accept button 122 and skip button 129. In another embodiment, the selection feature is a multi-purpose button. The printer A 130 may be any printer capable of receiving signals to print a coupon, either through wired or wireless signaling. The mobile device 140 may be a smart phone or a tablet. The computer 150 may be a laptop computer or a desktop computer.

The communications path 101 may be wired or wireless, or a combination of wired and wireless, and may include mechanisms to securely and effectively communicate between the network 20 and devices located at the television viewing location 100, including routers and switches, such as the switching device 103. For example, the communications path 101 may include a router that provides wireless Internet communications from the network 20 to each of the devices in the television viewing location 100, including the iTV 110. The communications paths 121, 131, 141, and 151 may be wired or wireless.

Television-enabled printing of coupons, in an embodiment, uses the display of a coupon interface (e.g., a GUI) 160 on a screen viewed by an individual. Such display may be on the iTV 110, the mobile device 140, and the computer 150. The coupon interface 160 may include a simple text message and one or more interactive features that can be used to control generation of a coupon request message. In FIG. 2, coupon interface 160 is shown displayed on iTV 110. Assuming the coupon interface 160 is displayed on the iTV 110, the individual may signal a desire to acquire the associated coupon. Such signal may be provided by using the remote 120, or by using the mobile device 140 or the computer 150. Signaling a desire to receive a coupon by interacting with the coupon interface 160 causes the generation of coupon request message 310, which then is sent to the coupon server 40. In return, the coupon server 40 generates coupon file 320, which can be rendered as hard-copy coupon 330 or electronic coupon (e-coupon) 340.

FIGS. 1 and 2 illustrate embodiments of environments in which media-enabled delivery of coupons occurs. Another embodiment of such an environment is a hotel room, where an individual is logged on to a service with a mobile device, and advertisements with triggers are displayed on the hotel room's television. An application in the mobile device detects the occurrence of a trigger, and the mobile device and coupon server operate to provide a coupon. For example, when the trigger is detected, the mobile device captures an audio fingerprint of the advertisement, and relays that data, perhaps with trigger data, time, date and GPS location of the mobile device, to a coupon server, where fingerprint recognition and coupon generation occurs. Yet another embodiment is an airport lounge or waiting area, which typically provide television programming. Again, a mobile device can detect the occurrence of a trigger, and the coupon request and delivery processes described above can be completed. In yet another embodiment, the mobile device is in a location with multiple televisions, and is able to distinguish between triggers and television shows.

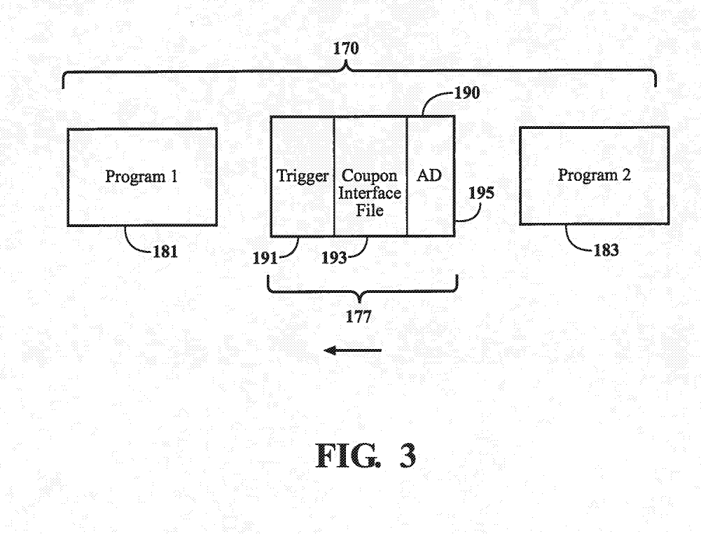

FIG. 3 illustrates an embodiment of a trigger used with television-enabled printing of coupons. In FIG. 3, media 170 is shown being displayed over time in the direction of the arrow. The media 170 includes a program having a first program file 181 and a second program file 183. Placed between the first and second program files 181 and 183, in an advertisement slot 177, is an advertisement file 190. The advertisement file 190 includes optional trigger 191, advertisement 195, and coupon interface file 193. The trigger 191 is placed at a leading edge of the advertisement 195. The coupon interface file 193 includes the data from which the coupon interface 160 is rendered by a processor in the iTV 110. The coupon interface file 193 may include data related to the display persistence of the coupon interface 160. For example, the coupon interface file 193 may indicate that the coupon interface 160 is displayed only during the duration of display of the advertisement 195. The iTV 110 processor detects the trigger 191, and renders and displays the coupon interface 160. That is, when the device displaying the programming segments 181 and 183 and the advertisement 195 reaches the trigger 191, programming in the device causes a coupon interface (e.g., coupon interface 160 of FIG. 2) to be displayed, either on the device, or on another device. For example, the iTV 110 may display the programming segments 181, 183, and the advertisement 195, but the coupon interface 160 is displayed on the mobile device 140. The same advertisement 195 could be scheduled for display without the optional trigger 191, in which case, the iTV 110 processor would not cause the coupon interface 160 to be displayed.

Note, however, that the trigger 191 need not be provided at the same time the advertisement 195 is provided, or at the same time the coupon interface file 193 is provided. Each of these three files may be provided at separate times, or in any combination. Furthermore, the advertiser 60 need not provide all three files. For example, the advertiser 60 could provide the advertisement 195, and a local franchisee could provide the trigger 191 and the coupon interface file 191.

In another embodiment, the trigger 191 is an audio signal, outside the hearing threshold of the individual, but detectable by an application on the mobile device 140. When the audio signal is detected, the mobile device 140 automatically sends a message to the coupon server 40 to generate the coupon interface file and then send the coupon interface file to the mobile device 140.

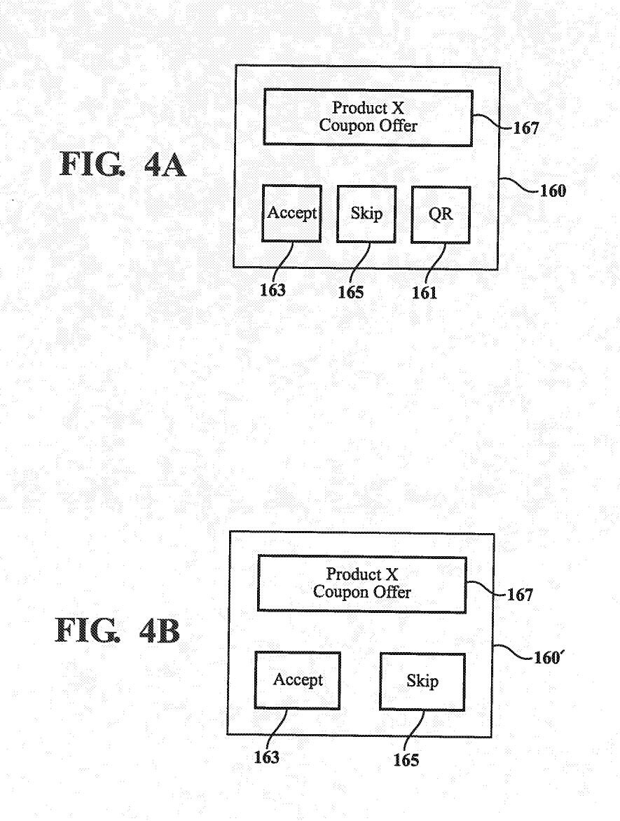

FIGS. 4A and 4B illustrate embodiments for a coupon interface used with television-enabled printing of coupons. The display of the coupon interface occurs when a trigger in an advertisement is sensed by a program executing on a processor of the iTV 110. Alternately, a trigger is not used, and the coupon interface is embedded in its associated advertisement.

In FIG. 4A, coupon interface 160, which is shown displayed at a corner of the screen of the iTV 110 in FIG. 2, includes quick response (QR) barcode 161, accept tab 163, skip tab 165, and message 167. The message 167 states that a coupon is available. The individual can signal a desire to receive the coupon by scanning the barcode 161 or by selecting the accept tab 163. Selection of the skip tab 165 signals the iTV 110 processor to remove the coupon interface 160 from display. The coupon interface 160 may persist long enough to allow scanning of the barcode 161 using, for example, the mobile device 140. Activation of the accept tab 163 can be made using the remote 120, the mobile device 140, or the computer 150.

FIG. 4B illustrates a coupon interface embodiment in which the iTV 110 and the mobile device 140 are at the viewing location 100 and are receiving signals over the network 20. When the trigger is sensed at the iTV 110, the iTV 110 sends a signal to the coupon server 40, which in turn sends coupon interface data to the mobile device 140. Using an application resident on the mobile device 140, coupon interface 160′ is displayed on the mobile device 140. In an alternative, the iTV 110 can communicate directly with the mobile device 140 to initiate display of the coupon interface 160′. Using the mobile device 140, the individual then can request the coupon from the coupon server 40. In yet another alternative, the iTV 110 can send basic information regarding the coupon interface 160′ to the mobile device 140, and the mobile device 140 can complete generation of the coupon interface by adding to the basic information, for example, an identification field that uniquely identifies the mobile device 140, and, by extension, the individual, and thereby completes the coupon interface. In still another alternative, the identification field is provided by the mobile device 140 to the coupon server 40 separately from the coupon interface 160′.

In either of the above-described coupon interface embodiments, the coupon interfaces 160/160′ may persist on display for a predetermined time, until a selection feature is activated (selecting the accept tab 163 or scanning the barcode 161), or selecting the skip tab 165. The predetermined time can extend to the entire display of the associated advertisement, or beyond the advertisement display end time. The coupon interface can be set to disappear upon detection of the next trigger in the media stream.

In an alternative, the interfaces 160/160′ do not include a skip tab, and instead, the interface persists until the end of the associated advertisement, or advertisement slot. In another alternative, the interface 160′ includes only a skip tab, and the coupon generation signal is automatically generated at the end of the associated advertisement.

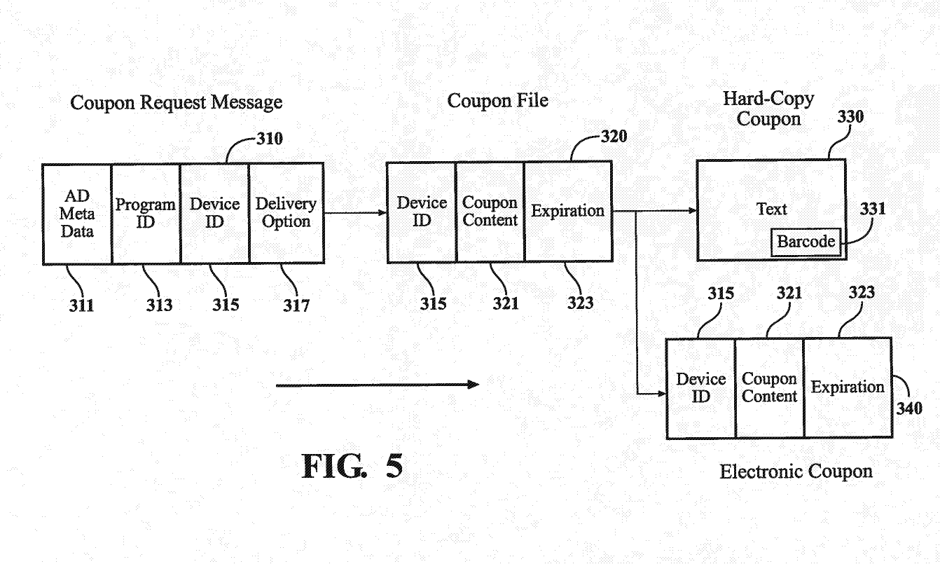

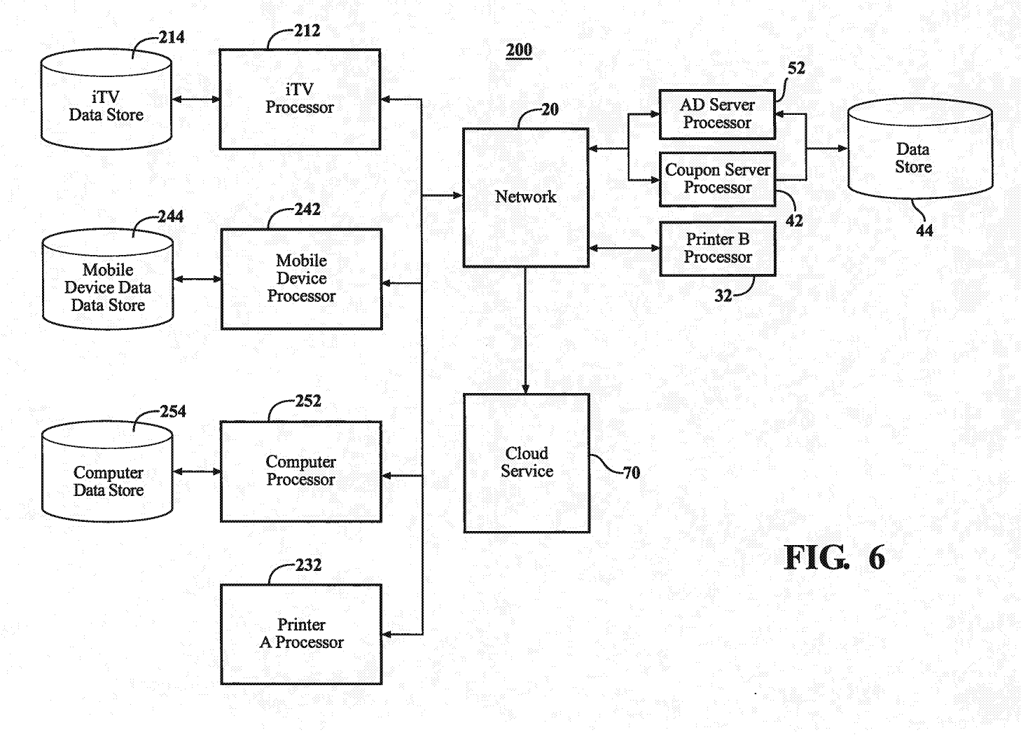

FIG. 5 illustrates an embodiment of the messages and files involved in requesting and generating a coupon using the systems of FIGS. 1 and 2. In FIG. 5, coupon request message 310 is sent from a device at the viewing location 100 to the coupon server 40 in order to obtain a coupon. The coupon request message 310 includes ad metadata segment 311, program identification segment 313, device identification segment 315, and delivery option segment 317. The ad metadata segment 311 includes an identity of the advertisement the time and date the ad was viewed (which may not coincide with the time and date the advertisement was broadcast or streamed), and the channel over which the advertisement was broadcast or streamed. The program identification segment 313 contains an identity of the program associated with the advertisement the device identification segment 315 includes an identification of the device over which the advertisement was displayed, and/or the identification of the device that originated the coupon request message 310, so as, optionally, to identify, the individual requesting the coupon, and the delivery option segment 317 indicated the individual's desired delivery preference, if selected.

At the coupon server 40, the coupon request message data are used to create coupon file 320, which is a digital representation of a corresponding hard copy coupon, and which includes the device identification segment 315, a coupon content segment 321, which includes information related to the offer represented by the coupon (e.g., 50% off normal price and data related to the and an expiration segment 323, which indicates when the coupon expires. Finally, the coupon file 320 includes instructions for formatting the coupon as a hard copy document or as an electronic coupon (e-coupon).

The coupon file 320 may be of any format, including a pdf file, a word document file, a digital offer code for online purchases, a quick response code, and a hypertext file, so long as the required elements of the coupon are incorporated into the file.

The coupon file 320 is sent to an output device, which may be a printer, where the file is printed as coupon 330. Coupon 330 includes any text and graphical portions, and barcode 331, which may encode data such as the offer (coupon content segment 321), an identity of the individual requesting the coupon, and the coupon's expiration. The individual identity can be used with the advertisement and program data to evaluate the efficacy of the advertisement.

The coupon file 320 also may be sent to a device, such as the mobile device 140, and stored therein as an e-coupon 340. The e-coupon 340 may include one or more of the device identification segment 315, coupon content segment 321, and expiration segment 323. The e-coupon 340 can be redeemed at a merchant's facility by scanning the bar code portion, or may be redeemed in an online purchase.

FIG. 6 is a block diagram of an embodiment of a system for television-enabled printing of coupons. In FIG. 6, television-enabled printing for coupons system 200 includes iTV processor 212, mobile device processor 242, printer A processor 232, and computer processor 252, all of which are hardware devices located in the corresponding devices shown in FIG. 2, which, as noted with respect to FIG. 2, reside at the television viewing location 100. Also located with the corresponding devices are iTV data store 214, mobile device data store 244, and computer data store 254.

Also shown in FIG. 6 are network (e.g. Internet) 20, which couples the processors 32, 212, 232, 242, and 252 to coupon server processor 42 and ad server processor 52, and data store 44, which supports the coupon server 40 and the ad server 50.

The various data stores shown in FIG. 6 contain programs or applications, that when executed by their associated processors, provide for television-enabled printing of coupons. That is, the data stores store specific applications or programs that, when executed, allow the individual devices shown in FIGS. 1 and 2 to support media-enabled delivery of coupons and television-enabled printing of coupons.

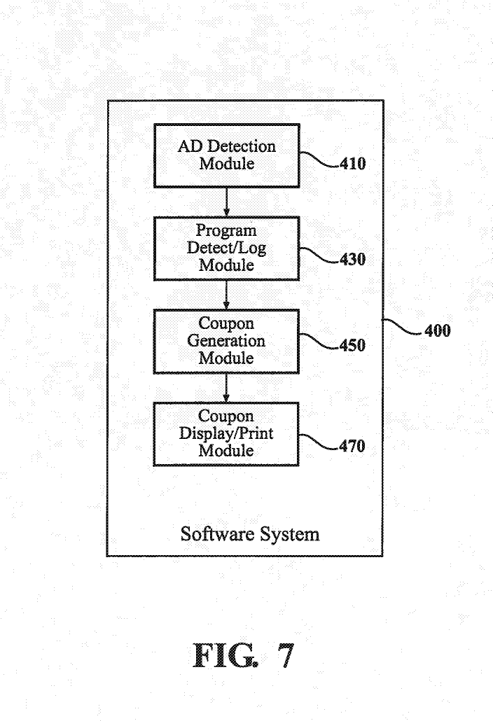

FIG. 7 is an overall block diagram of an embodiment of a software system that supports media-enabled delivery of coupons, including television-enabled printing of coupons. Although the illustrated system is a software system, all or part of the system could be implemented in hardware, firmware, or any combination of software, hardware and firmware. Software system 400 includes a number of software modules, programs, and engines that may be distributed, in various combinations, among the devices shown in FIGS. 1 and 2, and which may be executed, in various combinations, by the processors shown in FIG. 6.

Software system 400 may include advertising detection module 410, program detection/logging module 430, coupon generation module 450, and coupon display/print module 470. The advertising detection module 410 determines when an advertisement having an associated coupon is displayed on the iTV 110 The program detection/logging module 430 detects a specific program being displayed on the iTV 110, and may log this data for use by other components of the system 400, or by other devices, such as the ad server 50. The coupon generation module 450 determines when a coupon should be generated, and then generates the coupon. The coupon display/print module 470 determines if a coupon should be displayed, for example on the mobile device 140, determines if the coupon, whether or not displayed, should be printed, and if to be printed, where the printing should occur. These functions, and the specific structures of these software modules, will be explained in more detail below.

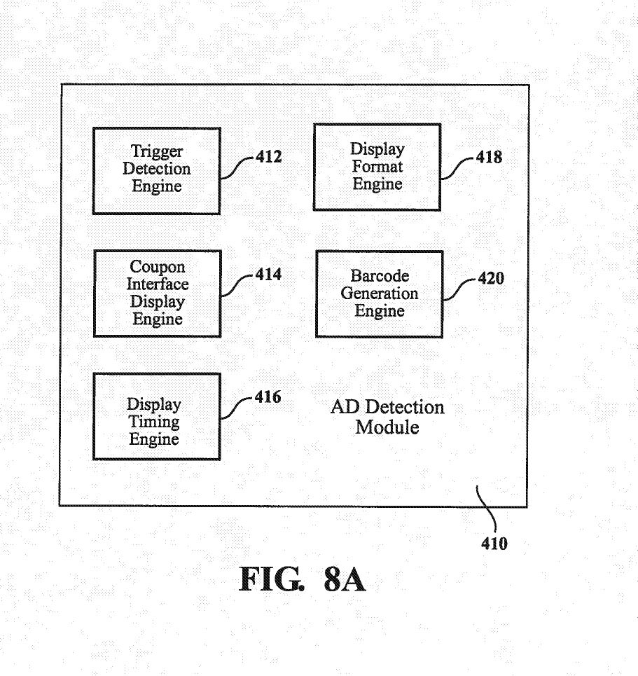

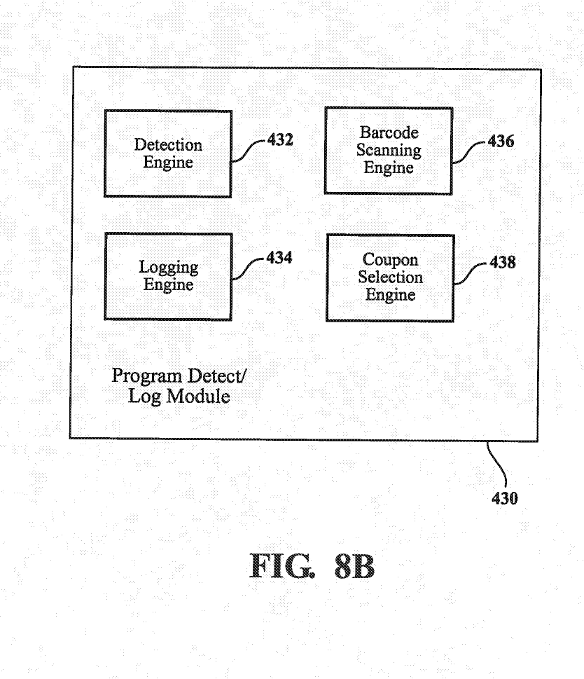

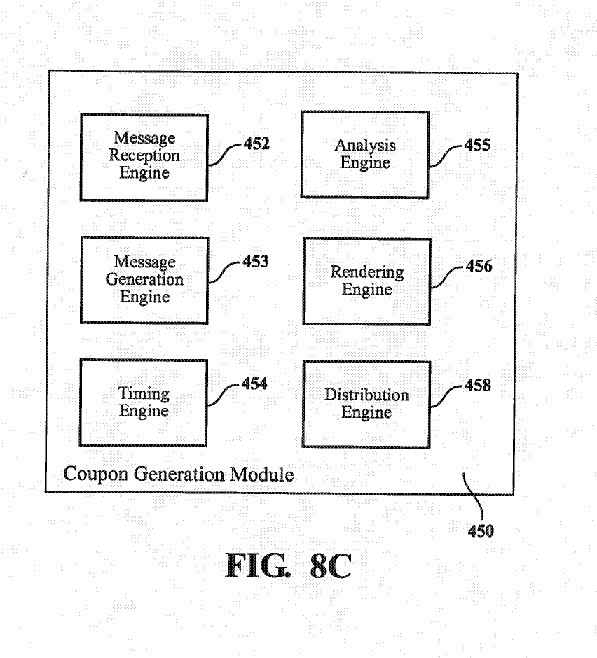

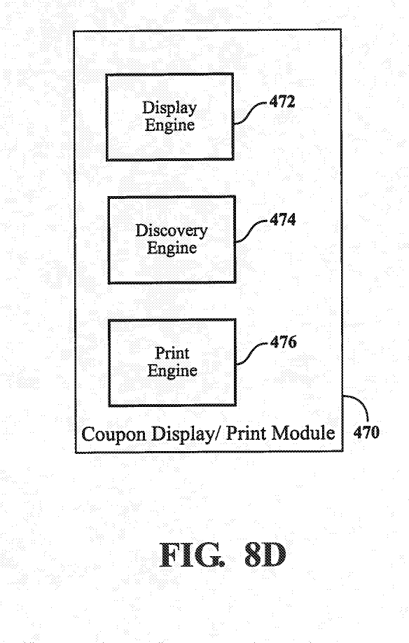

FIGS. 8A-8D are more detailed block diagrams of the software system 400 of FIG. 6. FIG. 8A illustrates the advertising detection module 410. The module 410 may include trigger detection engine 412, coupon interface display engine 414, display timing engine 416, display format engine 418, and barcode generation engine 420. The trigger detection engine 412 detects the presence of an embedded trigger in an advertisement being broadcast or streamed to the iTV 110. Alternately, the trigger detection engine 412 detects a trigger embedded in an advertisement in a game, or embedded in an advertisement in any other media capable of display on the iTV 110. The trigger is used to indicate to the trigger detection engine 412 that an advertisement associated with a coupon or voucher is, or will be, displayed on the display of the iTV 110.

The coupon interface display engine 414 determines, based on receipt of the trigger detection signal, and optionally other data inputs, whether to provide a display to an individual who may be viewing the advertisement. Other data inputs include a real-time clock signal. For example, if the trigger is embedded in an advertisement that has been recorded and is being played back, the real time clock signal can be used to determine a mismatch in time between the live or original display of the advertisement, and the recorded playback of the advertisement. In either of these two cases, the trigger would be detected. However, the advertiser may want the coupon made available only during the original display of the advertisement, or within a defined period of such original display. Thus, the coupon interface display engine 414 may have as an input, such a timing limitation. In one alternative, the timing limitation is included in the embedded trigger. In another alternative, the engine 414 may incorporate logic that disables display of the coupon interface after a prescribed period, such as one week. In yet another alternative, the coupon server 40 or ad server 50 provides the timing as a separate signal to the iTV 110. In an alternative to the above timing mechanisms, a coupon interface display timing mechanism may be incorporated into other modules of the system 400, as will be described below. In yet another alternative, the coupon interface may be provided on the mobile device 140 or the computer 150, with a different timing applied to the duration of display than would be used for display on the iTV 110.

The display timing engine 416 determines the start and stop time, or duration, of display of the coupon interface. For example, the coupon interface may be displayed during the entire display of the associated advertisement, during the entire advertising slot, or program break during which the advertisement is displayed, or may persist during display of the associated program (i.e., extend beyond conclusion of the program break).

The display format engine 418 controls the format of the coupon interface that is displayed to the individual. In an embodiment, the coupon interface includes as an overlay, a text message suggesting the user press an interface (e.g., on the remote 120) in order to receive a coupon. In another embodiment, the text message may contain more details about the coupon, such as the value of the coupon. FIGS. 4A and 4B illustrate two embodiments of the coupon interface.

In an embodiment, the triggers, coupon interfaces, and text messages may be set up using the Enhanced Binary Interchange Format (EBIFF) standard or the Multimedia and Hypermedia Experts Group (MHEG) standard.

In an embodiment the coupon interface 160 (see FIG. 2) includes a quick response (QR) bar code, or similar two-dimensional device, displayed on the iTV 110, and the individual viewing the advertisement uses the mobile device 140, equipped with a bar code scanning application, to download the data contained in the bar code into the mobile device 140. The mobile device 140 then communicates automatically with the coupon server 40 to obtain the coupon.

In an embodiment, the mobile device 140 uses an installed application to detect, by audio fingerprinting, a specific advertisement that includes the coupon trigger. The ad server 50 or coupon server 40 may pass the requisite audio fingerprints to the mobile device 140 for storage therein and processing by the processor 242 executing the audio fingerprinting application. The stored fingerprints may be updated periodically by the ad server 50 or the coupon server 40. Once the audio fingerprint is confirmed in the mobile device 140, the mobile device 140 automatically sends a message request to the processor 212 of the iTV 110 to display the coupon interface 160.

When the mobile device 140 is used to communicate a coupon request message to the coupon server 40, an application on the mobile device 140 may present the individual with a pop up text asking the individual to confirm that the individual wants the coupon request message sent to the coupon server 40.

As an alternative to direct communication of a coupon request to the coupon server 40, the mobile device 140 sends a signal to the iTV 110, and the iTV 110 sends the coupon request message to the coupon server 40.

FIG. 8B illustrates the program detection/logging module 430 in more detail. The program detection/logging module 430 allows a device to detect a specific program, advertisement, or media play by comparing indicia contained in the program, advertisement, or media to a known value. For example, the audio fingerprinting described above can be used for detecting a program, advertisement, or media play. Alternately, the detection can be based on visual indications or an embedded signal such as an audio signal or simply by noting the placement of the program, advertisement, or media based on channel, date, and time. The detection also can be based on an exchange of signals or messages between the device configured with the program detection/logging module 430, and the device displaying the program, advertisement, or media. For example, the detection can result from an exchange of messages between the iTV 110 and the mobile device 140.

The program detection/logging module 430 may include detection engine 432, logging engine 434, bar code scanning engine 436, and coupon selection engine 438. The detection engine 432 detects and identifies a program, advertisement, or media based on one or more of the above-mentioned indicia. The logging engine 434 is used to record the date, time and channel associated with a specific program, advertisement, or media play. The logging engine 434 additionally provides the recorded information to the ad server 50 or the coupon server 40, where the data are used to evaluate the effectiveness of an advertising campaign, among other uses. The bar code scanning engine 436 is used to scan the bar code 161 of the coupon interface 160. The coupon selection engine 438 is used to signal accept (in lieu of scanning a bar code, or when a bar code is not included in the coupon interface) or to signal skip in response to display of the coupon interface 160.

FIG. 8C shows the coupon generation module 450 in more detail. The coupon generation module 450 may include message reception engine 452, message generation engine 453, optional timing engine 454, analysis engine 455, rendering engine 456, and distribution engine 458. The message reception engine 452 receives a coupon request message, typically from the iTV 110 or the mobile device 140. The message generation engine 453 is used to generate the coupon request message. The optional timing engine 454 applies a time-based filter to the coupon request message to determine if the coupon should be generated. For example, the advertiser may place a two-week limit from the time of airing of the associated advertisement to coupon generation. When a coupon request message is denied based on a timing issue, the timing engine 454 optionally provides an error message that is sent to the device that originated the coupon request message.

The analysis engine 455 identifies the individual viewing the advertisement, and, using the received advertising metadata, an identity of the viewed advertisement. The individual's identity may be based on the individual's registration with a media or content provider, or an Internet address or a serial number or similar identification of the media device that received and displayed the advertisement or that generated the coupon request message.

The rendering engine 456 renders the desired coupon. The thus-rendered coupon may include a unique identification to set it apart from other coupons for the same product or service, and to identify the device that requested generation of the coupon. Thus, for example, the coupon may include the serial number of the iTV 110 or the Internet address associated with the mobile device 140. When the coupon is redeemed, this identification is collected and sent to the ad server 50. The rendering engine 456 may render the coupon as a digital file that is sent to another device, such as the iTV 110, the printers B 30 and A 130, the mobile device 140, or the computer 150.

FIG. 8D shows the coupon display/print module 470 in detail. The coupon display/print module 470 may include display engine 472, which provides for display of the coupon on a device such as the mobile device 140, printer discovery engine 474, which is used to discover available printers, and print engine 476, which provides a print command to print the associated digital file as a document, at for example, the printer A 130 or the printer B 30, when the individual desires to have the coupon printed directly. The print engine 476 includes decision logic to decide which printer to use for printing the coupon. For example, the print engine 476 may automatically print to the nearest discovered printer. The print engine 476 may present a dialog box that allows the individual to select a default printer, and to change specific printers on an ad hoc basis. Further, the print dialog box may give the individual an option set up to have one of the devices of FIG. 2 to direct the print operation. For example, the digital file (i.e., coupon file 320) representing the coupon may be sent to the iTV 110. The processor 212 of the iTV 110 then may direct the printer A 130 to print the coupon. When sent to the mobile device 140, the coupon may remain in a digital state (e.g., e-coupon 340), and may be redeemed directly from the mobile device 140. Alternately, the mobile device 140 may direct the printer A 130 to print the coupon. Printing of the coupon may occur as soon as the digital file is received at a device. Alternately, the device receiving the digital file may notify the individual that the coupon is available for printing.

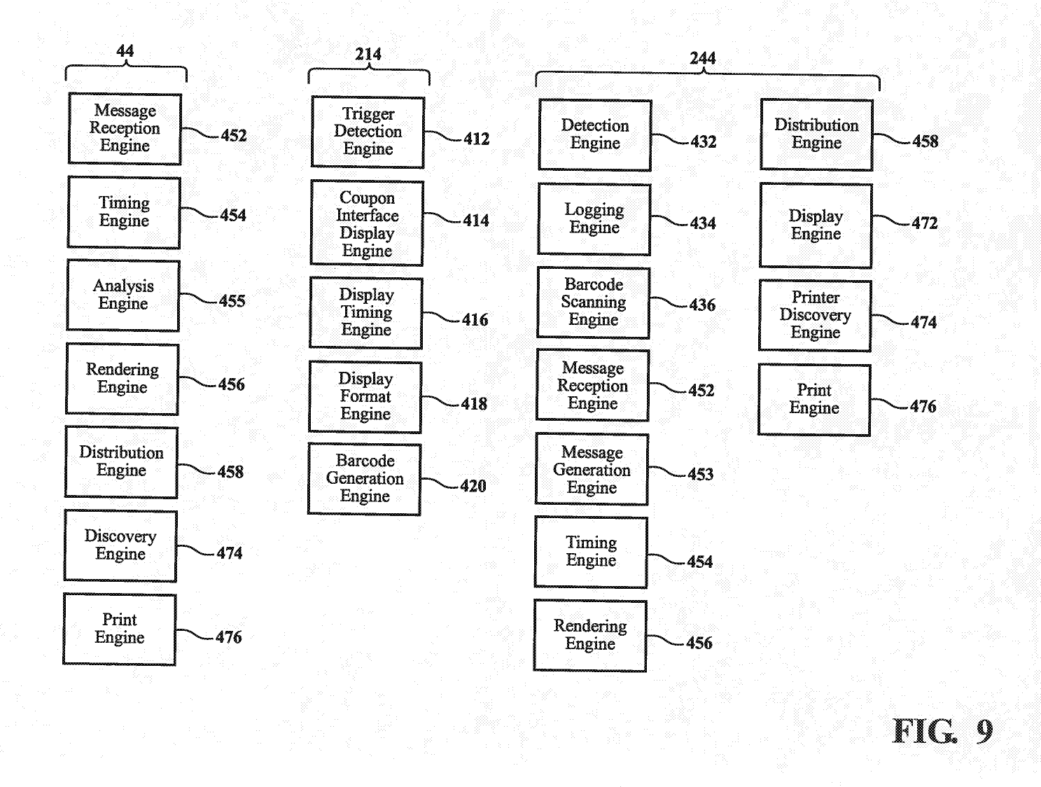

FIG. 9 illustrates an embodiment of the arrangement of programming modules distributed among the various devices shown in FIGS. 1 and 2, and using the components of FIGS. 3-8D. Note that many other arrangements are possible, and that some, programming modules may be duplicated and used among the various devices while other modules may not be used.

In FIG. 9, iTV 110, in viewing location 100, receives media by broadcast and streaming mechanisms, as well as by downloading mechanisms. The media include television programming, pay-per-view movies, games, email, data, and other media. Each of these media types may have associated one or more advertisements. One or more of these advertisements may include a coupon generation/delivery feature such as described above with respect to FIGS. 1-8D. Also operating in viewing location 100 is mobile device 140. The iTV 110 and the mobile device 140 are linked to, and are receiving media from, the network 20. The mobile device 140 is configured to display media received over the network 20. Printer A 130 is in a standby state and is connected to the iTV 110 and the mobile device 140 by communications paths 131 and 101, respectively. Printer B 30 is connected to the network 20 and is in a standby state.

The coupon server 40, located at advertiser 60, receives coupon request messages, and renders and delivers coupons, provided certain criteria are met. For example, the coupon server 40 includes logic to limit the number of coupons delivered to a specific individual, or to limit coupon delivery based on expiration of a time limit. The coupon server 40 may exercise a default option in delivering the coupon, or may deliver the coupon to a destination selected by the individual.

The coupon server 40 includes processor 42, which is coupled to data store 44. The data store 44 contains, and the processor 42 executes, programming code of message reception engine 452, timing engine 454, analysis engine 455, rendering engine 456, distribution engine 458, printer discovery engine 474, and print engine 476. These engines operate as described with respect to FIGS. 8C and 8D.

The iTV 110 includes processor 212 and data store 214. The data store 214 contains, and the processor 212 executes, programming code of the advertising detection module 410, including the trigger detection engine 412, coupon interface display engine 414, display timing engine 416, display format engine 418, and bar code generation engine 420. These engines function as described with respect to FIG. 8A.

The mobile device 140 includes processor 242 and data store 244. The data store 244 contains, and the processor 242 executes, programming code of program detection/logging module 430, including detection engine 432, logging engine 434, and bar code scanning engine 436; coupon generation module 450 including message reception engine 452, message generation engine 453, timing engine 454, rendering engine 456, and distribution engine 458; and the coupon display/print module 470, including the display engine 472, printer discovery engine 474, and print engine 476. These engines operate as described with respect to FIGS. 8B-8D.

Thus, in the embodiment shown in FIG. 9, the content provider 80 provides media 170, including advertisement 195 with associated trigger 191 and coupon file 193, for display at the iTV 110. The processor 212 of the iTV 110 detects, using trigger detection engine 412, the presence of the trigger 191 during display of the media 170. The processor 212, using coupon interface display engine 414, the display format engine 418, and the bar code generation engine 420, and the data contained in the coupon file 193, generates and displays coupon interface 160 on the screen of the iTV 110. The coupon interface 160 includes selection feature 161, which is a QR bar code embedded with the data from the coupon file 193, to which has been added the serial number of the iTV 110. Using the display timing engine 416, and persistence data included in the coupon file 193, the display timing engine 416 sets a time limit for display of the coupon interface 160.

The individual viewing the advertisement sees the coupon interface 160 displayed, decides to request the coupon, and elects to indicate such selection by scanning the bar code 61. The individual uses mobile device 140, and in particular, bar code scanning engine 436, to scan the bar code 161 and thus acquire the advertisement identification and the iTV 110 serial number. The scanning operation also causes the program detection engine 432 to capture the time and date of display of the advertisement, as well as the program identity, and the channel to which the iTV 110 is tuned. Finally, scanning the bar code 161 causes the display timing engine 416 in the iTV 110 processor 212 to remove the coupon interface 160 from display on the screen of the iTV 110.

Using the logging engine 434, the processor 242 of the mobile device 140 temporarily stores the gathered information in the data store 244. Then, using message generation engine 453, the processor 242 generates a coupon request message and sends the message to the coupon server 40.

The coupon server processor 42, using the message reception engine 452 receives the coupon request message. Using the timing engine 454 and the analysis engine 455, the processor 42 determines if the individual is eligible to receive the requested coupon. If the individual is eligible, the processor 42, using the rendering engine 456, renders the coupon including a unique identification or code that ties the coupon to the individual, and encodes a time limit for redemption of the coupon. Next, using the distribution engine 458, the processor 42 determines a distribution method for the coupon. The distribution methods may include a default distribution or a distribution selected by the individual either in advance, or at the time the coupon request message is sent to the coupon server 40. One such default distribution method is to send the coupon file to the device that originated the coupon request message, which in this embodiment, is the mobile device 140. Another distribution method is to send the coupon file to cloud service 70, where the coupon is printed or the coupon file is stored until the individual requests delivery of the coupon. The cloud service 70 can print the coupon at a designated printer or at a discovered printer. For example, the cloud service 70 can send the coupon file to remote printer B 30, where the coupon is printed for pick up by the individual. In the embodiment shown in FIG. 9, the coupon is printed at remote printer B 30.

Rather than receiving a printed coupon the individual may prefer to receive the coupon in an electronic form (i.e., as an e-coupon), and the e-coupon thus is sent to the mobile device 140. The individual may then redeem the e-coupon, either by entering a code for an online purchase, or by taking the mobile device 140 to a retail establishment, displaying the e-coupon on the mobile device screen, where it can be scanned by the retailer. Other distribution, delivery, and redemption mechanisms and methods are possible using the environments of FIGS. 1 and 2.

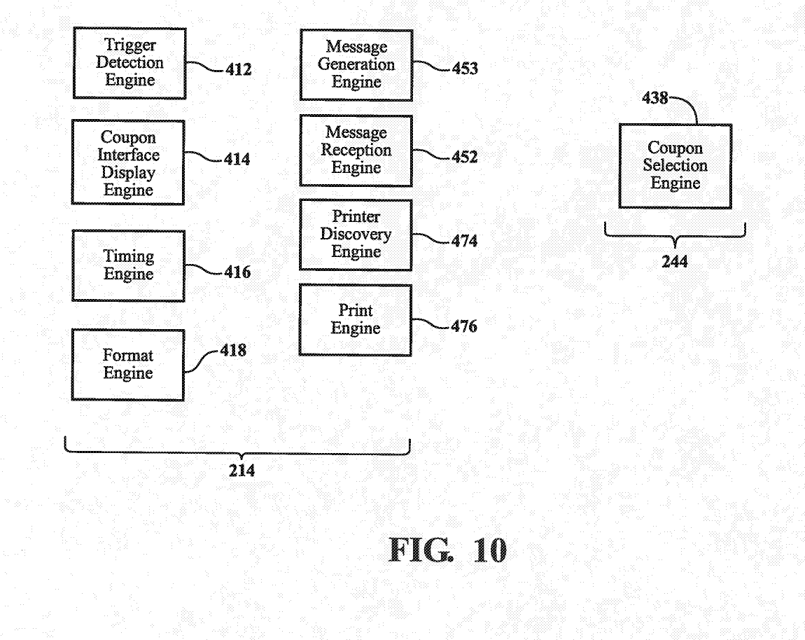

FIG. 10 illustrates another embodiment of the arrangement of programming modules distributed among the various components shown in FIG. 2. In FIG. 10, iTV 110, in viewing location 100, receives media by broadcast and streaming mechanisms, as well as by downloading mechanisms. The media include television programming, pay-per-view movies, games, email, data, and other media. Each of these media types may have associated one or more advertisements. One or more of these advertisements may include a coupon generation/delivery feature such as described above with respect to FIGS. 1-8D. Also operating in viewing location 100 is mobile device 140. The iTV 110 and the mobile device 140 are linked to, and are receiving media from the network 20. The mobile device 140 also is configured to display media received over the network 20. Printer A 130 is in a standby state and is connected to the iTV 110 and the mobile device 140 by communications paths 131 and 101, respectively. Printer B 30 is connected to the network 20 and is in a standby state.

The iTV 110 includes processor 212 and data store 214. The data store 214 contains, and the processor 212 executes, programming code of, the advertising detection module 410, including the trigger detection engine 412, coupon interface display engine 414, display timing engine 416, and display format engine 418. The data store 214 further includes message generation engine 453, message reception engine 452, printer discovery engine 474, and print engine 476. These engines operate as described with respect to FIGS. 8C and 8D and FIG. 9.

The mobile device 140 includes processor 242 and data store 244. The data store 244 contains, and the processor 242 executes, programming code of coupon selection engine 438. This engine operates as described with respect to FIG. 8B.

The coupon server 40 includes programming code to interact with the iTV 110.

Thus, in the embodiment shown in FIG. 10, the iTV 110 detects a trigger, formats coupon interface 160′, and displays the coupon interface 160′ on the screen of the iTV 110. The iTV processor 212 determines when the coupon interface display should begin, and when it should end. In an embodiment, the information used to control the persistence of the coupon interface 160′ is provided by the ad server 50. The individual then may use the mobile device 140, which employs processor 242 executing coupon selection engine 438, to indicate acceptance of the coupon offer. The acceptance signal is received by the iTV processor 212. The iTV processor 212, using message generation engine 453, generates a coupon request message, and sends the coupon request message to the coupon server 40. In return, the iTV 110 receives a coupon file 320. The iTV processor 212 determines which delivery mechanism to use for coupon delivery. For example, the iTV processor 212 may discover available printers, and send a print command and the coupon file 320 to printer A 130.

As an alternative to coupon acceptance using the mobile device 140, the remote 120 may be used to signal acceptance (or rejection) of the coupon offer by operating a dedicated interface or a multi-purpose interface on the remote 120 as directed in the text portion of the coupon interface 160′.

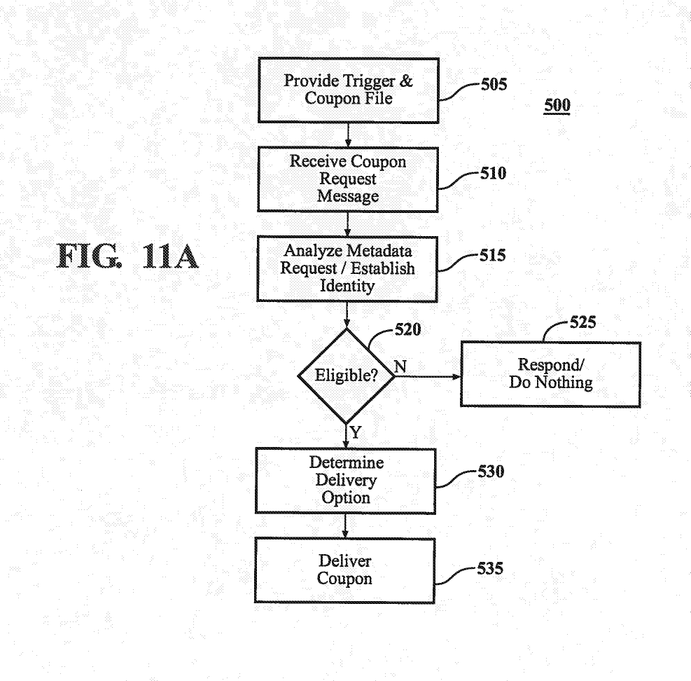

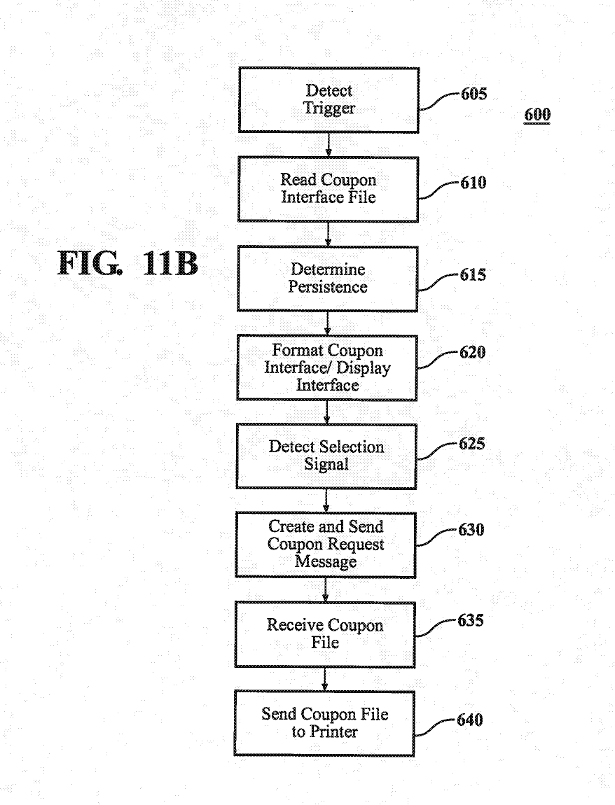

FIGS. 11A and 11B are flow charts illustrating embodiments of methods for television-enabled printing of coupons. The methods described below are based on the devices and components, and their arrangements, as shown in FIGS. 1-10, and more specifically FIGS. 9 and 10.

FIG. 11A is a flow chart illustrating an embodiment of a method corresponding to the programming arrangement of FIG. 9. In FIG. 11A, coupon delivery method 500 begins in block 505 when advertiser 60 provides trigger 191, to be associated with advertisement 195, where the advertisement 195 be displayed during display of media 170. In one alternative the advertiser 60, at the time of providing the trigger, also provides the advertisement 195 and coupon data file 193 to enable a processor at the viewing location to format and display an appropriate coupon interface. In another alternative, one or more coupon data files 193 are provided to a device at the viewing location 100 in advance of providing the trigger, and the coupon data files 193 are stored in a data store of the device. In either alternative, the provided trigger 191 and coupon data file 193 include a cross-reference field so that the appropriate trigger can be attached to the correct coupon data file. The advertisement 195, trigger 191, and coupon data file 193 may be sent to the content provider 80 for inclusion in the media 170. Other mechanisms are possible for reception of the trigger 191, coupon data file 193, and advertisement 195 at the viewing location 100.

In block 510, the coupon server 40 receives coupon request message 310 requesting generation and delivery of a coupon based on an offer displayed on a device at the viewing location 100. The coupon request message 310 provides data and metadata associated with the advertisement 195, the associated program identification of the device that generated the coupon request message, and possibly identification of the individual viewing the advertisement 195. The coupon server 40 may save some or all of these data for later use and action, in addition to processing the data to create a coupon.

In block 515, the coupon server 40 analyzes the data contained in the coupon request message 310 in order to prepare and distribute the requested coupon. This analysis may include determining the identity of the individual, and determining if the individual has designated a preferred delivery/print option.

In block 520, the coupon server 40 determines if the individual is eligible to receive the requested coupon. The eligibility determination may include determining if the coupon offer has expired and determining if the individual already has been issued a coupon from this offer. If the individual is determined not to be eligible (No (N) at block 520), the method 500 moves to block 525 and no further action is taken, or, optionally, the coupon server 40 sends a message to the device requesting the coupon, where the message indicates the coupon is not available.

If in block 520, the eligibility determination is Yes (Y), the method 500 proceeds to block 530. In block 530, the coupon server 40 determines what the designated delivery option is, if any. If no delivery option is designated, the coupon server 40 selects a default delivery option, which, in an embodiment, is to send the coupon file 320 to the device that originated the coupon request message. Thus, the coupon file 320 would be sent to the mobile device 140, block 535, and the mobile device 140 would direct printing of the coupon 330 at printer A 130, for example. Alternately, the mobile device 140 could use the cloud service 70 to print the coupon 330. Assuming the individual has designated a delivery and a print option, the coupon server 40 will send the coupon file 320 to the appropriate device to have the coupon 330 printed. In the embodiment of FIG. 10, the coupon file 320 is sent to, and the coupon 330 is printed at, remote printer B 30, block 535. Following block 535, method 500 ends.

FIG. 11B is a flow chart illustrating another embodiment of a coupon delivery method. The flow chart of FIG. 11B corresponds to the programming arrangement of FIG. 10. In FIG. 11B, coupon delivery method 600 begins in block 605, when iTV processor 212 detects trigger 191 in media stream 170. In block 610, the processor 212 reads the corresponding coupon interface file 193, including whether the coupon interface includes a bar code. In block 615, the processor 212 determines the persistence of the associated coupon interface. In block 620, the processor 212 formats coupon interface 160′, and displays coupon interface 160′ on the screen of the iTV 110.

In block 625, the processor 212 detects selection of the accept tab 163 on the coupon interface 160′. Note, however, that if instead, the skip tab 165 is selected, or if the designated persistence of the coupon interface 160′ expires, the processor 212 will remove the coupon interface 160′ from display.

When the accept tab 163 is selected the processor 212 creates a coupon request message similar to that discussed above with respect to FIG. 11A. In particular the coupon request message may identify the originating iTV by serial number, or otherwise identify the individual requesting the coupon. The processor 212 then sends the coupon request message to the coupon server 40, block 630.

In block 635, the iTV processor 212 receives the coupon file 320 from the coupon server 40. Alternately, the coupon server 40 can send the coupon 330 as pdf document. In block 640, the processor 212 sends the coupon file 320, or pdf document, to the local printer A 130 for printing. The method 600 then ends.

The preceding disclosure refers to a number of flow charts and accompanying descriptions to illustrate the embodiments represented in FIGS. 11A and 11B. The disclosed devices, components and systems contemplate using or implementing any suitable technique for performing the steps illustrated in these figures. Thus, FIGS. 11A and 11B are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium also can be, or can be included in, one or more separate physical components or media such as multiple CDs, disks, or other storage devices.

The herein disclosed methods can be implemented as operations performed by a processor on data stored on one or more computer-readable storage devices or received from other sources.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and it can be deployed in any form, including as a stand-alone program or as a module component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communication network. The relationship of client and server arises by virtue of computer programs running on the respective computers and having a client-server relationship to each other. In some embodiments a server transmits data (e.g., an HTML page) to a client device (e.g., for purposes of displaying data to and receiving user input from an individual interacting with the client device). Data generated at the client device (e.g., a result of the user interaction) can be received from the client device at the server.

1. A method for media-enabled delivery of coupons, comprising:
providing an advertisement to a media display device, the advertisement provided in a media stream for display to a viewer on the media display device;
providing, by a processor, in the media stream, a trigger for the advertisement;
receiving a trigger activation signal from the media display device;
providing a coupon acquisition interface comprising coupon acquisition options, at the media display device;
receiving a coupon generation request for a coupon;
receiving an identity of the media display device and metadata related to a display of the advertisement;
determining, by the processor, coupon generation eligibility of the media display device;
receiving a coupon delivery option from the media display device; and
delivering the coupon.

2. The method of claim 1, wherein the media stream is television programming, and wherein the media display device is an Internet-enabled television.

3. The method of claim 2, further comprising receiving the coupon generation request from the television.

4. The method of claim 2, further comprising:
providing a coupon prompt on an Internet-enabled media display device separate from the television; and
receiving, in reaction to the coupon prompt, the coupon generation request from the Internet-enabled media display device separate from the television.

5. The method of claim 1, wherein the media display device is registered with a media delivery service, and receiving an identity of the media display device comprises receiving an account number associated with the registration.

6. The method of claim 1, wherein receiving the metadata comprises receiving a time and date of display of the advertisement, and an identification of a communications path over which the advertisement is delivered, and wherein the metadata identify a specific display of the advertisement.

7. The method of claim 6, further comprising linking the coupon generation request to the specific display of the advertisement.

8. The method of claim 1, wherein determining eligibility for generation and delivery of the coupon comprises determining if the viewer previously requested generation of the coupon.

9. The method of claim 1, wherein the coupon has an expiration based on date and time, and wherein determining eligibility for generation and delivery of the coupon comprises determining if the coupon has expired.

10. The method of claim 1, wherein determining a coupon delivery option comprises determining if the coupon is to be printed.

11. The method of claim 10, further comprising sending a print command to a networked printer.

12. The method of claim 11, further comprising receiving an identification of a desired printer from the viewer, wherein the print command is sent to the identified printer.

13. The method of claim 10, further comprising sending a print command to the media display device, wherein the media display device is configured to send the print command to a networked printer.

14. The method of claim 1, wherein determining a coupon delivery option comprises determining if the coupon is to be sent to a mobile device.

15. A method for television-enabled delivery of coupons, comprising:
receiving, by a processor, a coupon offer trigger appended to a specific advertisement displayed in a media stream on a television;
activating the trigger;
displaying, by the processor, a coupon interface, the coupon interface including a coupon request selection feature;
receiving a coupon request selection signal;
generating, by the processor, in response to the coupon request selection signal, a coupon request message; and
sending, by the processor, the coupon request message to a coupon server.

16. The method of claim 15, further comprising:
receiving a coupon interface file, the coupon interface file including data related to the coupon offer; and
formatting the coupon interface, based on the coupon interface file, for display to a viewer.

17. The method of claim 15, wherein generating the coupon request message comprises:
collecting metadata associated with the advertisement;
collecting identification information related to a device displaying the advertisement; and
formatting the coupon request message to include the metadata and the identification information.

18. The method of claim 15, wherein the coupon selection feature comprises a quick response bar code.

19. The method of claim 15, wherein the coupon selection feature comprises an accept tab.

20. The method of claim 19, further comprising receiving a signal activating the accept tab.

21. The method of claim 15, further comprising displaying the coupon interface on a device separate from the television.

22. The method of claim 15, further comprising:
receiving a coupon file from the coupon server; and
sending the coupon file and a print command to a printer, wherein a desired coupon is printed.

23. The method of claim 22, further comprising receiving an identification of a desired printer, wherein the coupon file and the print command are sent to the identified printer.

24. The method of claim 15, further comprising:
determining a persistence period for display of the coupon interface; and
removing the coupon interface from display upon reaching an end of the persistence period.

25. A system for media-enabled delivery of coupons, comprising:
a media display device comprising a display over which a media stream is shown; and
a processor operative to:
receive a coupon offer trigger, the trigger tied to a specific advertisement,
display a coupon interface, the coupon interface including a coupon request selection feature,
receive a coupon request selection signal,
generate, in response to the coupon request selection signal, a coupon request message, and
send the coupon request message to a coupon server.

26. The system of claim 25, wherein the media stream comprises programming and advertisements, wherein the media device is an Internet connected television, and wherein the media stream is displayed on the Internet connected television.

27. The system of claim 25, wherein the coupon selection feature of the coupon interface comprises a quick response bar code, wherein the bar code includes metadata related to an advertisement, wherein the bar code is scanned to generate the coupon request message, and wherein the coupon request message comprises:
a coupon request; and
the advertisement metadata.

28. A system for media-enabled delivery of coupons, comprising:
a media-enabled device having a display screen; and
a processor operative to:
display an advertisement on the display screen,
receive a coupon offer trigger related to the advertisement, the trigger representing a presence of a coupon offer related to the advertisement,
display a coupon selection feature in an interface,
display the interface on the display screen,
activate a selection feature in the
acquire metadata related to the advertisement,
send the metadata, an identifier of the media-enabled device, and a coupon request in a message to a coupon server remote from the media-enabled device,
receive coupon data and a print command to print the coupon, and
send the coupon data and the print command to print the coupon to a printer.

29. A non-transitory computer-readable storage medium encoded with instructions that, when executed by a processor, causes the processor to perform operations comprising:
display an advertisement;
receive a coupon offer trigger related to the advertisement, the trigger representing a presence of a coupon offer related to the advertisement;
display a coupon selection in an interface;
display the interface on a display screen of an Internet-enabled television;
activating a selection feature in the interface;
acquiring metadata related to the advertisement;
sending the metadata, an identity of the television, and a coupon request in a message to a coupon server remote from the television;
receiving coupon data and a print command to print the coupon; and
sending the coupon data and the print command to print the coupon to a printer.
